(19) United States
(12) Patent Application Publication
(10) Pub. No.: US 2006/0196990 A1
(43) Pub. Date: Sep. 7, 2006

(54) Paper roll core adapter

(76) Inventor: Marcus T. Wallace, Tullahoma, TN (US)

Correspondence Address: WADDEY & PATTERSON, 1600 DIVISION STREET, SUITE 500, NASHVILLE, TN, 37203, US

(21) Appl. No.: 11/363,225

(22) Filed: Feb. 27, 2006

Related U.S. Application Data
(60) Provisional application No. 60/658,120, filed on Mar. 3, 2005.

(51) Int. Cl. B32B 37/12; B32B 37/00; B32B 38/10; B32B 1/08; B65H 75/10

(52) U.S. Cl. 242/609.4; 156/293; 156/294; 156/305; 428/36.91

(57) ABSTRACT

A core adapter for a core of a roll of sheet material allows the inside diameter of the core to be reduced. The core adapter is constructed of two or more concentric fiberboard tubes with a thermoplastic or thermosetting adhesive filling an annulus between the tubes.

This application claims priority from U.S. Provisional Patent Application Ser. No. 60/658,120 filed Mar. 3, 2005 for the invention by Marcus T. Wallace, of Tullahoma, Tenn. of a “Paper Roll Core Adapter.”

### FIELD OF THE INVENTION

The present invention relates generally to a device and the construction thereof for reducing the inside diameter of a paper roll or similar sheet products supplied in large rolls and means for connecting to the inside core.

### BACKGROUND OF THE INVENTION

In a number of industries, sheet products are provided in large heavy and bulky rolls having an inside core diameter. Heavy grades of material require winding upon a core having a large internal diameter. Subsequently, these rolls must be usable on available printing or processing machinery having a small diameter capability.

Sometimes it may be desirable to adapt to a small diameter even before the material is wound upon the core.

In addition, sometimes during the handling, storage, and use of the large rolls, the inside of the rolls become deformed or damaged making the roll unusable unless the damaged area is refurbished.

Often metric sizes are encountered which must be used on machinery designed for inch dimensions.

Often a metal cap having a drive notch is required to be installed within the core.

In addition a method is required to securely connect the device to the paper roll core.

Presently, several known devices and methods are used in the industry to adapt the inside diameter to a usable size. However, most of these known methods and devices have numerous drawbacks and are limited in scope. For example, one known method is to insert a tube of the required outside and inside diameter. This requires the correct outside diameter in order to achieve a secure press-fit with the existing core. This method requires a multiplicity of sometimes-special order tube sizes to accommodate various core sizes that may be encountered. These known devices require the use of hydraulic machinery for installation.

The known prior art devices also lack the capability of easily and economically providing the correct dimension or method for achieving a secure fit with the paper roll core. Also the known methods do not allow the use of a metal insert.

What is needed, then, is a device and method for adapting the inside diameter of large rolls of material, such as rolls of paper, into a usable diameter at one location using readily available parts. The device should be capable of handling a variety of sizes for both outside and inside diameter cores. This device should be economical to manufacture. This device should be able to be recycled with the other waste generated by the printing process. This device should provide a secure connection with the paper roll core. The device should be capable of having a metal end cap installed.

### SUMMARY OF THE INVENTION

This patent teaches a device for adapting a large internal diameter paper roll core to a smaller internal diameter and methods for connection.

The invention is designed to adapt a large roll of rolled sheet material, such as paper, paper products, sheet plastic, foil, or sheet composite material to a smaller desired internal diameter. This disclosure teaches several methods for making this adapter in a variety of dimensions and manner of construction using readily available materials. Additionally the invention provides a variety of methods for attaching the device to the paper roll core. Additionally a steel end cap may be incorporated within the device.

In a first embodiment, the invention includes an outer tube and an inner tube with the annulus filled with a polymer based adhesive such as a thermoplastic adhesive material that becomes solid at normal environmental temperatures or a thermosetting resin. The outer tube is perforated and the inner tube is counter-drilled. This arrangement of holes and counter-drills allows the adhesive to enter and form sections that increase the strength of the device.

For large reduction in diameter, say 12-inch to 3-inch; three or more intermediate diameter tubes may be utilized to allow use of readily available material of construction.

In another embodiment, tubes may be used to form voids in the polymer based adhesive material in order to reduce the amount of materials of construction.

In another alternate embodiment, grooves are substituted for the holes and counter-drilled holes described in the first embodiment.

In another alternate embodiment, a thermosetting material may be substituted for filling the annulus and thus forming an integral device.

One method for attaching the device to the core is by providing dimensions that cause an interference fit between the inside diameter of the paper roll core and the outside diameter of the device. When the device is forced into the core the interference fit that occurs provides a secure connection. Additionally an adhesive is applied to the exterior of the device to further enhance the integrity of the interface of the mating parts.

Additional strength is achieved by adding connecting elements at the interface between the inside diameter of the core and the outside diameter of the adapter. Holes are drilled axially into the adapter and the paper roll core, the center of the hole being located at the junction of the two parts. Dowel pins are then driven into the holes thus securing the two parts. Alternately, steel lag screws may be substituted for the dowels. A third method is to inject a thermoplastic or thermosetting material into the drilled holes instead of the dowel pins or screws.

The aforementioned tubes used in the construction are normally readily available from recycling core tubes having previously been wound with paper. Thus tube sizes of the correct inside dimension are available. Likewise, when metal end caps are required, recycled cores are selected for the adapter that already has the end cap installed. In those instances where a preinstalled metal end cap is unavailable a metal end cap may be installed using available portable end cap insertion machinery.

### BRIEF DESCRIPTION OF THE DRAWINGS AND PHOTOGRAPHS

FIG. 1 shows a paper roll having a large diameter core to be reduced to a smaller diameter.

FIG. 2 shows an outer perforated tube and an inner tube with counter drilled holes.

FIG. 3 shows a large tube, a small tube, and a centering ring to be located along a common centerline.

FIG. 4 shows the parts of FIG. 3 just prior to being positioned for injection of a polymer based adhesive.

FIG. 5 shows the assembly of the parts of FIG. 4.

FIG. 6 shows the parts of FIG. 5 with the centering ring trimmed away thus providing the final configuration of the invention.

FIG. 7 shows the adapter being inserted into the paper roll core.

FIG. 8 shows the installed adapter and details of the securing dowel (×3).

FIG. 9 shows a core tube having a metal end cap for use as the inside tube of the invention.

FIG. 10 shows a cross section of the adapter showing the location of the polymer based adhesive that connects the inside and outside adapter tubes.

FIG. 11 shows a cross section of an adapter having slots to receive the polymer based adhesive.

FIG. 12 shows a side view of a cutter mechanism for achieving the correct outside diameter of an adapter prior to insertion into a paper roll core.

FIG. 13 shows an end view of the adapter inserted into a paper roll core having securing devices.

FIG. 14 shows an end view of an adapter having multiple tube elements for large diameter reductions.

FIG. 15 shows an end view of an adapter having been constructed with voids to reduce the volume of adhesive required.

FIG. 16 shows a final side view of a paper roll core having adapters inserted. One end shows a perforated type adapter secured with lag screws while the other end shows an adapter of slotted construction secured with dowel pins.

### DESCRIPTION OF THE PREFERRED EMBODIMENTS

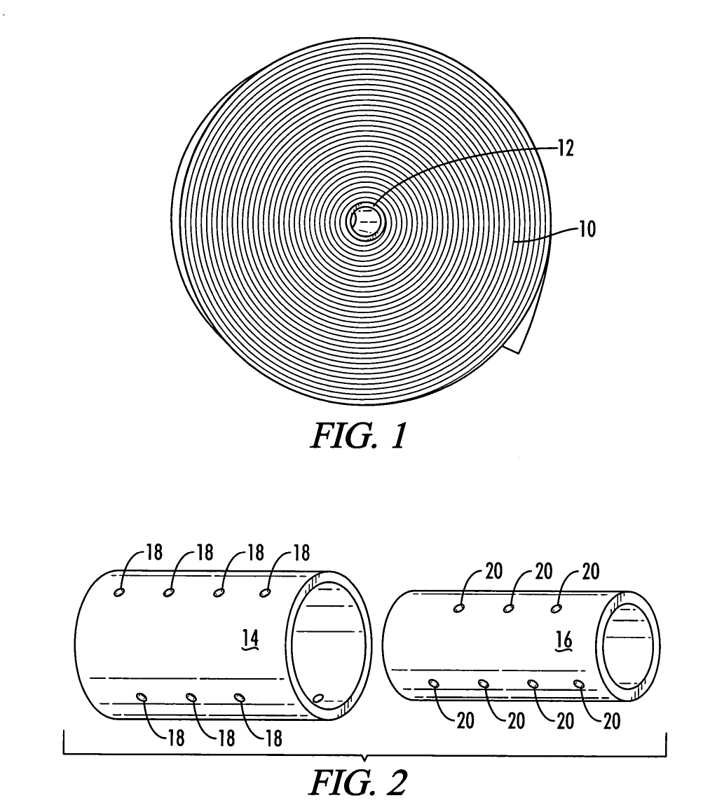

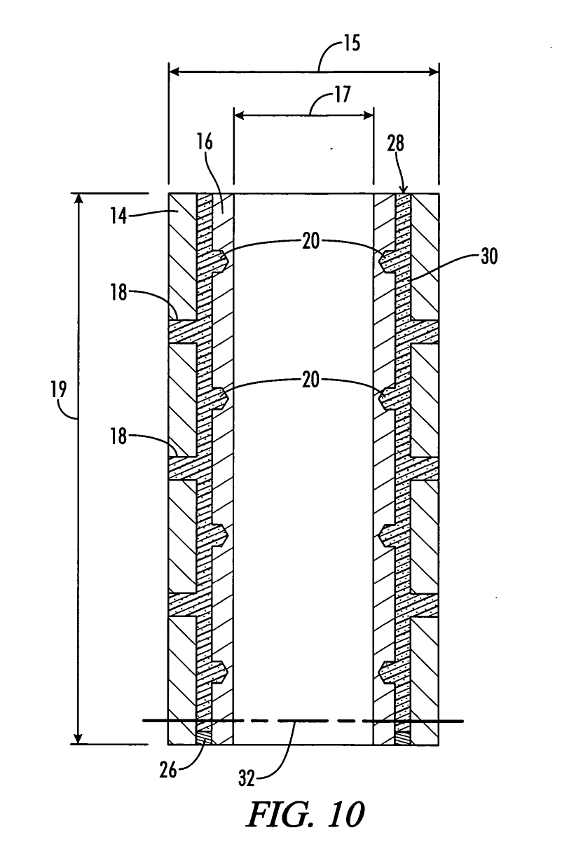

Referring now to FIG. 1, a large paper roll 10 is shown, having a core 12 with inside diameter needing to be reduced to a smaller diameter. FIG. 2 shows a larger outer tube 14 having an outside diameter 15 (see FIG. 10) approximating the inside diameter of the core 12 of FIG. 1. Typically this diameter 15 is 6-inches but diameters as large as 12-inches are often encountered. Also shown is a smaller tube 16 having the desired inside diameter 17. Typically this diameter 17 is 3-inches but may be otherwise. Typically the tube lengths 19 (see FIG. 10) are approximately 12-inches long. The core 12, which is sometimes referred to as a fiber core or a fiberboard tube, is constructed from a very dense fibrous paper-board like material.

The outer tube 14 of FIG. 2 has been drilled with two rows of three holes 18 and two rows of four holes 18. The number of rows and the number of holes may vary. Typically these holes are ½-inch diameters but could be otherwise. These rows are approximately 90-degrees apart.

The inside tube 16 of FIG. 2 has counter bored or blind bore cavities or holes 20 which do not penetrate the wall. This is to block the flow of adhesive that will be inserted later.

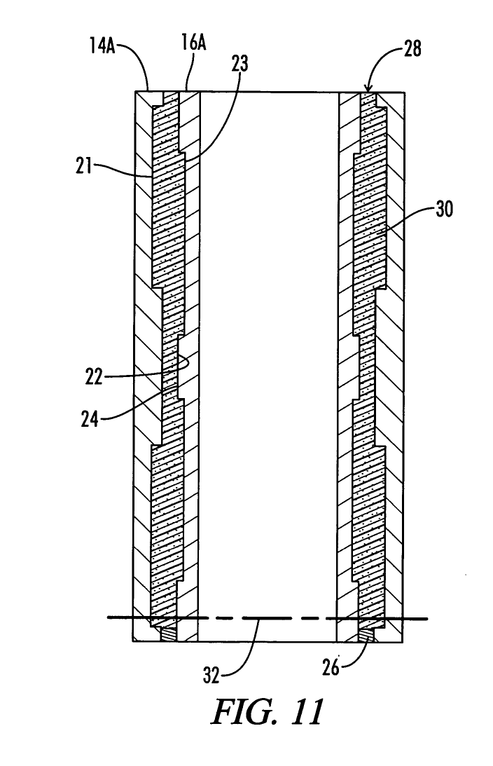

An alternate construction (shown in FIG. 11) is to form slots 21 in the inside surface 22 of the outer tube 14A and form slots 23 in the outside surface 24 of the inner tube 16A. These slots 21 and 23 are typically ¼-inch wide and ¼-inch deep and perhaps 3-inches long. These slots are staggered in four rows located 90-degrees apart.

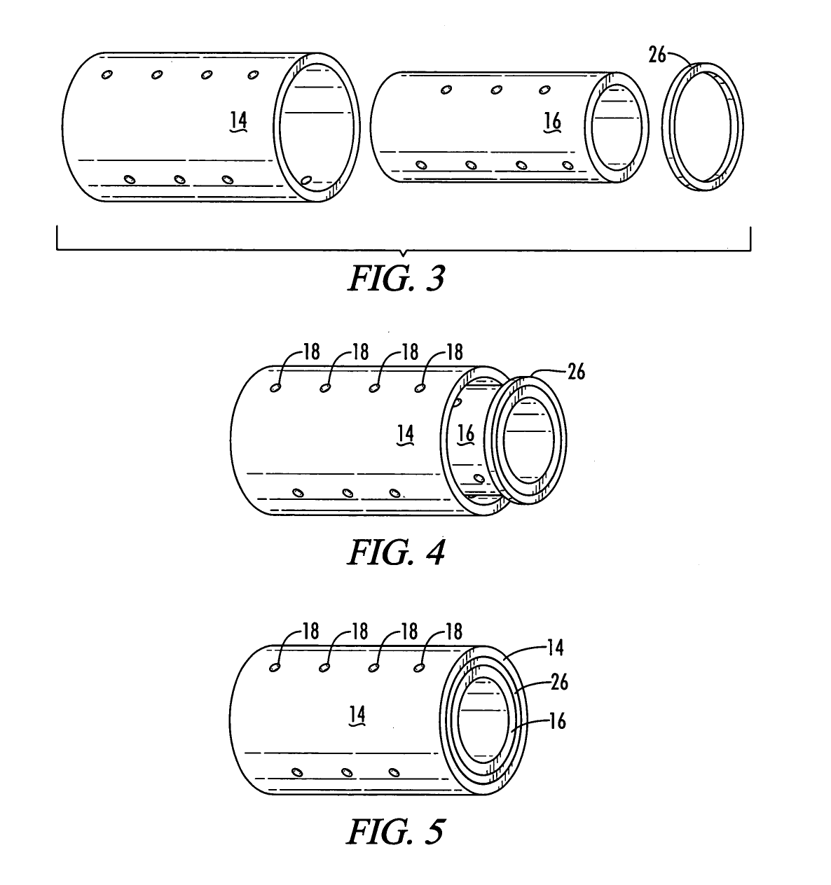

A centering ring 26 is shown in FIG. 3. Made of a plastic material, it is used to concentrically locate the two tubes 14 and 16, and act to plug the annulus 28 (see FIG. 10) during later injection of the adhesive filler 30 (see FIG. 10). Assembly of these parts is sequentially shown in FIGS. 3, 4 and 5.

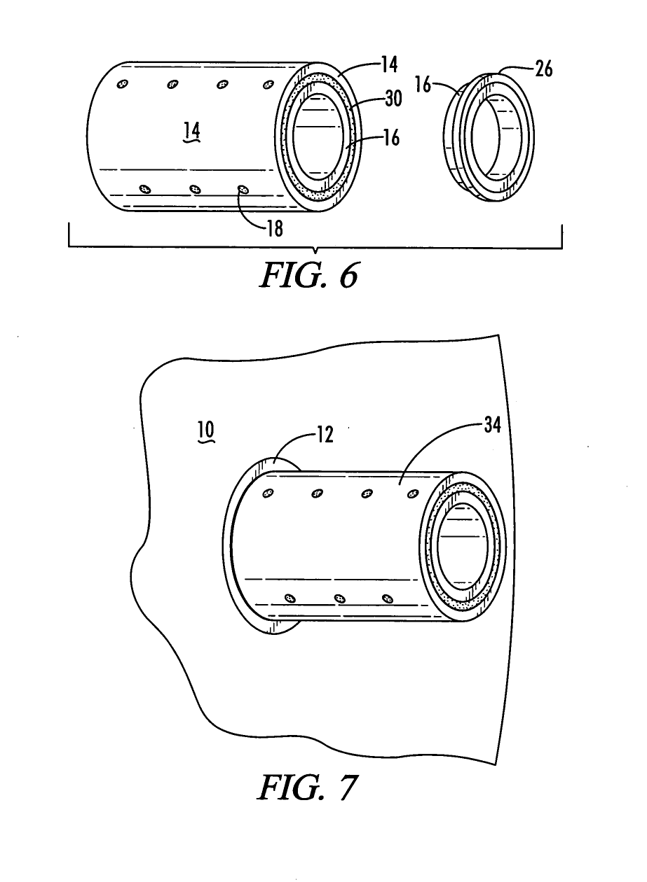

This assembly of FIG. 5 is then oriented with the central axis vertical as shown in FIG. 10. A polymer based adhesive 30 is poured or injected into the hollow annulus 28 between the two tubes. During the filling operation, the outer ends of holes 18 should be plugged with tape or with a suitable fixture. After the adhesive solidifies the end of the adapter having the ring is trimmed away as shown in FIG. 6 thus resulting in the adapter 34. The location of trim line 32 is shown in FIG. 10. Typically a band saw is utilized to perform the trimming operation. The trimming operation allows for reuse of the ring 26 and prevents contamination of the recyclable waste; however, the ring may be left intact.

Although a plastic ring 26 is described other materials could be used. Additionally, three or four segments of a ring may be utilized to locate the tubes on a mutual centerline. In this instance the tubes would be placed in a fixture to prevent escape of the adhesive 30.

The polymer based adhesive may either be a thermoplastic adhesive or a thermosetting material. If a thermosetting material is used, careful selection may be necessary if recyclability is required. Usually such thermosetting materials are two components that cure by chemical action the results being a much stronger adapter. It is presently believed that the preferred polymer based adhesive is the thermosetting material, due to its superior strength. One example of such a thermosetting material is a two component epoxy consisting of a resin and hardener used to fill the annulus between the inner and outer tubes. A suitable resin component is available from Cook Composites & Polymers Co., 820 E. 14th Ave., North Kansas City, Mo. 64116, under the trade name Stypol 040-5739. This resin can be generically described as an unsaturated polyester in monomer. A suitable hardener component is available from Norac, Inc., 405 S. Motor Ave., Azusa, Calif. 91702, under the trade name Norox MEKP-900. This hardener can be generically described as methyl ethyl ketone peroxide (MEKP).

Additional cross sections showing details of the various parts and construction are shown in FIGS. 10 and 11. Shown is the location of the adhesive 30 into the holes and slots which provides additional shear area needed to resist torque loads imposed on the assembly by the printing and other processing machinery that may be encountered in use.

Three Tube Adapter of FIG. 14

The FIGS. 1-13 only show two tubes 14 and 16 being required to adapt from say six inch to three-inch; however, additional tubes could be included to adapt from larger sizes. For example: As shown in FIG. 14 to adapt from twelve inch to six inches or three-inch may require several tubes selected from available standard wall thickness that would result in the desired results. The method of construction shown would be similar to that described for two tubes. For example, with reference to FIG. 14, a core adapter 100 is shown in place within the core 12 of paper roll 10. Core adapter 100 includes an outer tube 102 having an outside diameter sized to be closely received within the inner diameter of core 12. An inner tube 104 is received within the outer tube, and an intermediate tube 106 is received within the annulus between the outer tube 102 and the inner tube 104 thus dividing the annulus into an outer annulus 108 and inner annulus 110. Both the outer annulus 108 and the inner annulus 110 are filled with adhesive material. The method of construction of the three tube core adapter 100 is substantially like that shown above for the two tube adapter of FIGS. 1-13.

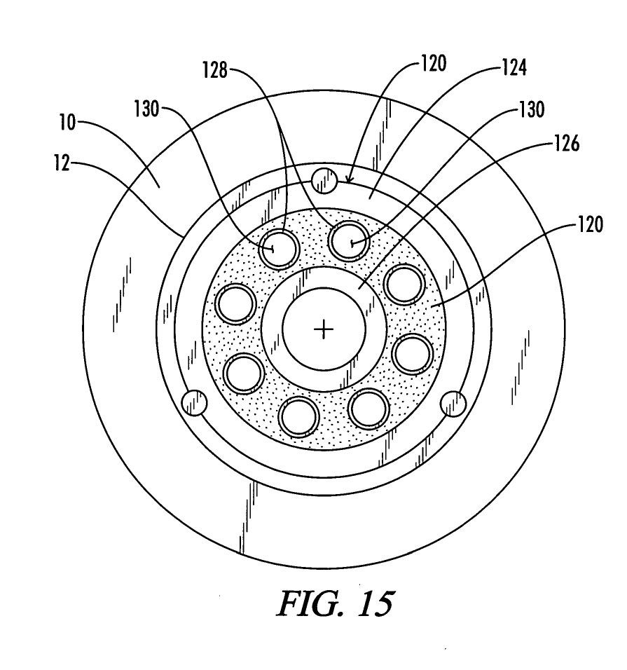

Cavity Tubes of FIG. 15

FIG. 15 shows a method of construction that uses an inside and outside tube but voids are formed by the addition of cavity tubes which reduces the volume of filler material when adapting from say 12-inch to three-inch diameter. Eight tubes are shown but the number and size may vary from that shown. In FIG. 15 a core adapter 120 is shown in place within a core 12 of a paper roll 10. The core adapter 120 includes an outer tube 122 and an inner tube 124 with an annulus 126 defined therebetween. Prior to filling the annulus 120 with adhesive material, a plurality of longitudinally extending cavity tubes such as 128 are placed in the annulus 120. In the example of FIG. 15 there are eight cavity tubes 128. Then the remaining annulus surrounding the cavity tubes is filled with adhesive material which is allowed to harden. This results in a plurality of longitudinally extending cavities 130 being defined in the adhesive material which occupies the annulus 120 so that the amount of adhesive material in the annulus 120 is reduced.

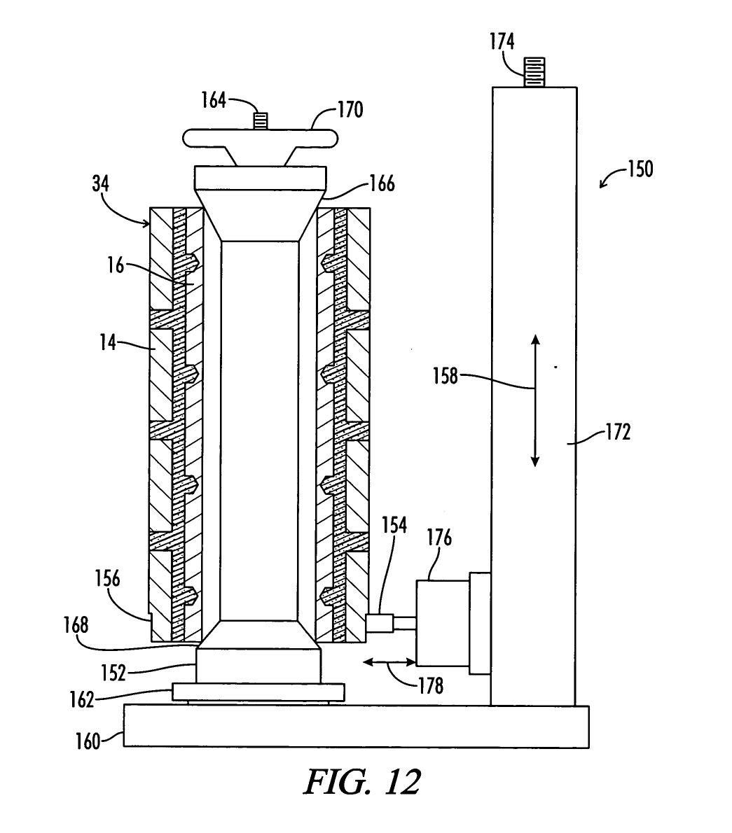

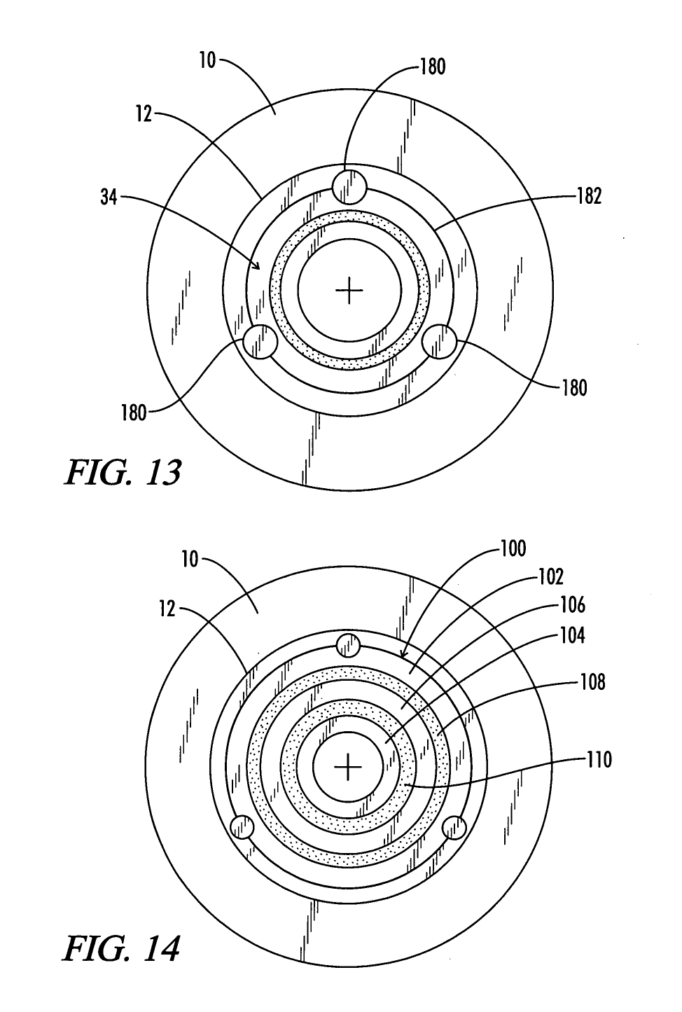

Sizing Device of FIG. 12

In order to use the invention it is necessary to provide the correct dimension for mating with the paper roll core 12 that is being resized. Referring to FIG. 12 showing a side view of a sizing device 150 that is utilized to achieve either a light press fit or a slip fit between the adapter 34 and the inside of the paper roll core 12. The sizing device 150 centers the adapter 34 on a spindle 152. The spindle 152 rotates and a cutter 154 is advanced into the adapter 34 to achieve the desired outside diameter 156. The cutter 154 is traversed along the axis of the core via router movement up or down in the direction of arrows 158 until the entire outer tube 14 has been resized. The sizing device 150 has a base 160 which contains the various drive mechanisms for the spindle and the router. The spindle 152 is mounted on a turntable 162 which rotates upon the base 160. The spindle lead screw 164 extends upward from turntable 162. An upper centering cone 166 and lower centering cone 168 of spindle 152 are received in the inside diameter of inner tube 16 and are snugly engaged therewith via hand wheel 170 which threadedly engages lead screw 164.

A router column 172 extends vertically upward from base 160 and a power lead screw 174 extends therethrough. A cutter 154, which in the example shown is a conventional router head 154, is mounted on a router motor 176. The cutter 154 may be adjusted horizontally as indicated by arrows 178 to adjust the depth of cut into the outer tube 14 of core adapter 34. The router motor 176 and cutter 154 are moved vertically upward as indicated by arrows 178 through the action of power to lead screw 174 which carries the router motor and cutter assembly vertically upward along router column 172 so as to make the cut in the outside diameter of outer tube 14 along its entire length.

After the correct outside diameter has been achieved the adapter 34 is positioned into the paper roll core 12 as shown in FIG. 7. An adhesive is applied to the mating surfaces and the adapter 34 is then driven or slid into the core 12 until flush with the end of paper roll 10. The adhesive between the adapter 34 and paper roll 12 is preferably a vinyl adhesive such as that available from Bird Song Adhesives, Inc., 801 E. Old Hickory Blvd., Madison, Tenn. 37115, under the trade name BSA-220. This vinyl adhesive may be generically referred to as an ethanol homopolymer.

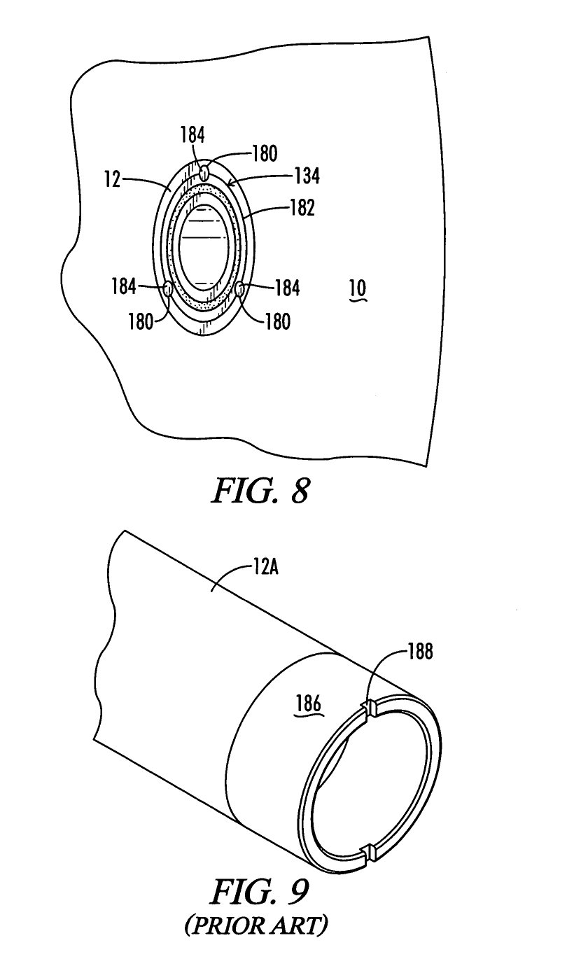

As shown in FIG. 8, the adapter 34 is additionally secured by drilling typically three holes 180 into the adapter and core interface 182. Typically the holes 180 are ½-inch diameter and three inches deep but the diameter, quantity, and depth may vary depending upon the selection of a securing structure or retainer 184. These additional retainers 184 are to enhance the ability to resist torque loads imposed by rotation of the rolls 10 during use.

In a preferred embodiment the retainer devices 184 are wooden dowels that are driven into the drilled holes 180. One advantage of the wooden dowels is that they do not contaminate the recyclable cores. The diameter of the drilled holes is such as to provide a press fit with the dowels. Additionally, adhesive is applied to the dowels before being inserted.

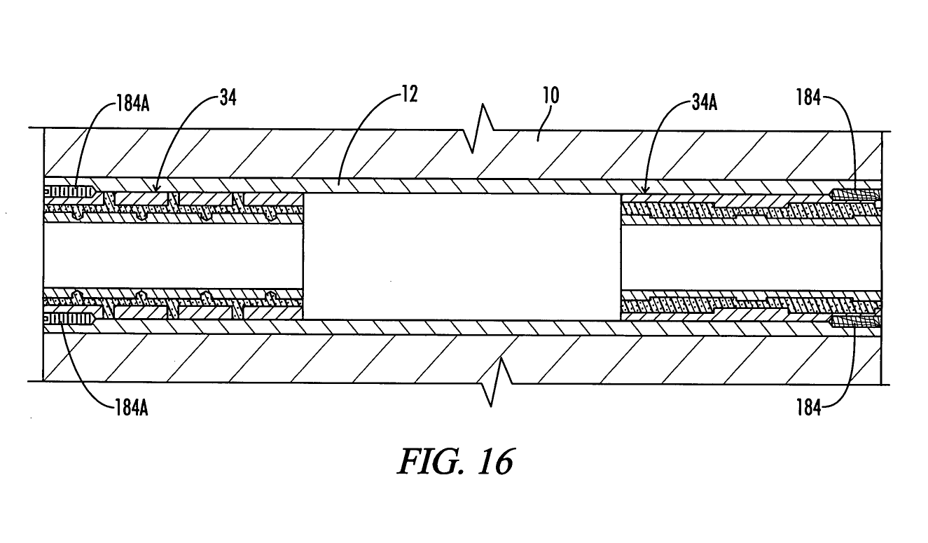

In an alternate embodiment as illustrated on the left side of FIG. 16, steel lag screws 184A are utilized instead of dowels. The screws 184A provide additional strength, which may be needed even though it detracts from the recycle ability of the Waste core.

In a third embodiment a thermosetting adhesive, such as the two part resin and hardener described above, may be injected or poured into the drilled holes 180. In this method the diameter of holes 180 may be larger typically, ⅞-inch.

The completed installation is shown in FIG. 8. Shown is the adapter 34 inserted into a paper roll core 12. Holes 180 were drilled and three wooden dowels 184 having been inserted.

In those instances when a metal end cap is required a core tube 12A as shown in FIG. 9 is selected for use in fabricating the adapter. The core tube 12 is a conventional prior art core tube having a metal end cap 186 with a drive notch 188.

Methods of Operation

A method for adapting a paper roll 10 inside diameter to a smaller preferred diameter is disclosed. FIG. 1 shows a paper roll 10 having core 12 having an internal core diameter needing to be reduced to a smaller diameter.

Determination is made as to the paper roll core inside diameter and the desired final diameter. Outer and inner tubes 14 and 16 are then selected from readily available core tubes as shown in FIG. 2 or FIG. 9 (if a metal end cap is needed). Typically two tubes would allow adapting from six inch to three-inch size inside diameters. Larger size ranges could require additional tubes like shown in FIG. 14. Various wall thickness may be chosen to adapt to the desired dimension including metric sizes. Normally these tubes are selected from readily available tubes that are waste products from the printing process.

Once the tubes are selected they are cut to length using readily available saws. The typical length is thirteen inches to allow trimming to a final size of twelve inches. Longer or shorter length may be used.

The outer tube 14 is prepared for use by drilling a series of holes 18 radially into the outer surface. These holes are shown in FIG. 2, typical being ½-inch diameter. Other sizes may be used. Typically there are two rows of four holes and two rows of three holes. The hole patterns are staggered and the rows are 90-degrees apart.

The inside tube 16 has a similar pattern of holes 20 except that the holes 20 do not pass through the wall of the tube 16. This is to prevent the adhesive from exiting through the holes. These counter-drilled holes are approximately ½-inch diameter by ½-inch deep.

A centering ring 24 is obtained that will fit over the inner tube 16 and inside of the outer tube 14. This serves to concentrically locate the tubes as well as prevent the escape of the adhesive that will now be installed.

Referring to FIGS. 4 and 5 will reveal how the assembly may now be located with it axis vertical (not shown). An open space or annulus now exists between the tubes. This space is open at the top of the assembly as shown in FIG. 10. An appropriate polymer based adhesive is selected. If the adhesive is a thermoplastic adhesive it is heated until molten. It is then poured into the open end 28 of the adapter and allowed to solidify. If several tubes are used then each annulus is filled with adhesive as shown in FIG. 14.

An alternate method of construction is to use a thermosetting material such as a two component epoxy for the filler material.

An alternate method of construction is to substitute four segments (not shown) instead of a ring 26 in order to obtain concentricity of the tubes 14 and 16. In this method additional care must be taken to prevent adhesive from leaking past the segments. This may be accomplished by fixturing the tubes 14 and 16 to a flat surface during filling of the adhesive.

The adhesive is allowed to cool and/or harden. The end of the adapter containing the centering ring 26 is trimmed away along line 32 using a conventional saw. This removes about ½-inch of material including the ring 26, as shown in FIG. 6, which may then be reused.

To prepare the adapter 34 for use the inside diameter of the paper roll core 12 must be carefully measured. Likewise the outside diameter of the adapter 34 is either known or must be measured. The difference determines the amount of material that must be removed to provide interference fit between the adapter 34 and the core 12. The preferred interference is from 0.005 to 0.010 inches. In some instances a slip fit may be desired. In this case the outside diameter of the adapter 34 would be less than the inside diameter of the core 12.

The desired outside diameter of the adapter is achieved by utilizing the sizing device 150 shown in FIG. 12. The adapter 34 is placed upon the lower centering cone 168 of the spindle 152. The upper centering cone 166 is placed into position and tightened with the hand-wheel 164. This centers the adapter 34 that may then be rotated with the turntable 162.

The cutter blade 154, driven by router motor 176 is advanced radially into the rotating adapter as indicated by arrows 178 until the desired diameter is achieved. The cutter is then advanced upward and parallel to the vertical axis of the adapter as indicated by arrows 158. In this fashion the entire outer surface of adapter 34 is resized to the desired dimension. The adapter 34 is now removed from the trimming device 150 ready for use.

The next step is to apply a suitable adhesive, such as the vinyl adhesive from Bird Song Adhesive described above, to the outer surface of the adapter 34 and the inside surface of the paper roll core 12. The adapter 34 is placed into position to be forced into the paper roll core 12, as shown in FIG. 7. Typically, a hammer applies this force until the end of the adapter 34 is flush with the paper roll core 12. Adapters 34 are installed into each end of the paper roll 10.

The final step is to further secure the adapter 34 to the core 12. Three holes 180 are drilled into the end of the core 12 and the adapter 34. FIG. 13 shows a preferred arrangement of these holes 180, the center of which are on the interface 182 between the adapter 34 and core 12. The preferred embodiment is to insert retainers 184 such as wooden dowel pins into these holes. The typical hole diameter is ½-inch and two inches deep. The hole 180 diameter is selected to provide an interference fit when the dowel 184 is driven into the hole 180.

The dowel 184 is cut to length and adhesive applied to the surface. The dowel 184 is driven into the hole 180 until flush with the adapter 34 thus completing installation of the adapter 34.

In a second embodiment steel lag screws 184A (see FIG. 16) may be substituted for the dowels 184. In this instance the hole 180 diameter is selected according to the recommended tap drill size for the screw 184A selected. Slotted type lag screws 184A allow the screw to be installed flush with the adapter 34 so as not to interfere with the printing equipment.

In another embodiment the drilled holes 180 may be filled with a thermosetting adhesive to form a retainer 184. In this instance the hole diameter should be increased to perhaps ⅞-inch to provide a greater shear surface. In this instance the paper roll 10 must be positioned with the central axis vertical to allow the adhesive to be poured into the holes 180.

In these instances three holes 180 are shown; however, a different number of holes 180 may be utilized.

Thus it is seen that the methods and apparatus of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A core adapter for reducing an inside diameter of a core of a roll of sheet material from a first dimension to a second dimension, comprising:
an outer tube having an outside diameter sized to be closely received within the inside diameter of the core;
an inner tube received within the outer tube and defining an annulus between the outer tube and the inner tube, the inner tube having an inside diameter equal to said second dimension; and
a hardened adhesive material occupying the annulus.

2. The core adapter of claim 1, wherein:
the outside diameter of the outer tube is greater than said first dimension by a sufficient amount that said outer tube may be interference fit within the core.

3. The core adapter of claim 1, wherein:
the outside diameter of the outer tube is less than said first dimension so that said outer tube may be slip fit within the core.

4. The core adapter of claim 1, further comprising:
an intermediate tube received in the annulus between the outer tube and the inner tube, and dividing the annulus into an outer annulus and an inner annulus, and
wherein the adhesive material occupies both the outer annulus and the inner annulus.

5. The core adapter of claim 1, further comprising a plurality of longitudinally extending cavities defined in the adhesive material occupying the annulus, so that the amount of adhesive material in the annulus is reduced.

6. The core adapter of claim 1, wherein the adhesive material is a thermoplastic material.

7. The core adapter of claim 1, wherein the adhesive material is a thermosetting material.

8. The core adapter of claim 1, wherein:
the inner tube has a plurality of radially inward extending blind cavities defined in a cylindrical outer surface of the inner tube, the blind cavities being filled with adhesive material to strengthen a connection between the inner tube and the adhesive material.

9. The core adapter of claim 8, wherein the blind cavities are radial bores.

10. The core adapter of claim 8, wherein the blind cavities are slots extending parallel to a longitudinal axis of the core adapter.

11. The core adapter of claim 1, wherein:
the outer tube has a plurality of cavities extending radially therethrough, the cavities being filled with adhesive material.

12. The core adapter of claim 1, received in the core, and further comprising:
a plurality of longitudinal extending securing structures closely received in longitudinal bores spanning an interface between the inside diameter of the core and the outside diameter of the outer tube.

13. The core adapter of claim 12, wherein the securing structures are wooden dowel pins.

14. The core adapter of claim 12, wherein the securing structures are metal lag screws.

15. The core adapter of claim 12, wherein the securing structures are hardened adhesive material.

16. The core adapter of claim 1, wherein the outer tube and the inner tube are formed of lengths of fiber core.

17. The core adapter of claim 1, wherein the outer tube and the inner tube are recycled cores of other rolls of sheet material.

18. A method of reducing an inside diameter of an inner bore of a core of a roll of sheet material, said method comprising:
(a) locating an inner tube within an outer tube so that an annulus is defined therebetween;
(b) flowing a liquid adhesive material into the annulus and permitting the adhesive material to harden so that the inner tube and the outer tube are structurally connected together by the hardened adhesive material to form a core adapter;
(c) placing the core adapter in the inner bore of the core; and
(d) securing the core adapter to the core.

19. The method of claim 18, wherein:
in step (c) the core adapter is interference fit within the inner bore of the core.

20. The method of claim 18, wherein:
in step (c) the core adapter is slip fit within the inner bore of the core.

21. The method of claim 18, further comprising:
prior to step (c), reducing an outside diameter of the outer tube by removing material from the outer tube.

22. The method of claim 18, wherein:
step (d) includes placing an adhesive material between the core adapter and the inner bore of the core.

23. The method of claim 18, wherein:
step (d) includes forming a plurality of longitudinal bores spanning an interface between the core adapter and the core, and placing securing structures in the longitudinal bores.

24. The method of claim 18, further comprising:
placing an intermediate tube between the inner and outer tube thereby separating the annulus into an outer annulus and an inner annulus.

25. The method of claim 18, further comprising:
providing a plurality of cavities in the outer tube and the inner tube, the cavities being communicated with the annulus; and
wherein step (b) includes flowing the liquid adhesive material into the cavities in the outer tube and the inner tube.

26. The method of claim 18, wherein:
in step (b) the adhesive material is a thermoplastic material.

27. The method of claim 18, wherein:
in step (b) the adhesive material is a thermosetting material.

28. The method of claim 18, further comprising:
prior to step (b), closing an end of the annulus with a centering ring; and
after step (b) and before step (c), cutting off an end of the core adapter to remove the centering ring from the core adapter.

29. The method of claim 18, further comprising:
prior to step (b), spacing the inner tube from the outer tube with a centering structure, and closing an end of the annulus.

30. The method of claim 18, further comprising:
prior to step (b), partially occupying said annulus with a plurality of longitudinally extending radially offset cavity tubes; and
in step (b), flowing the liquid material outside of said cavity tubes so that the cavity tubes define cavities in the annulus thus reducing the amount of liquid adhesive required to occupy the annulus.
